(19) United States
(12) Patent Application Publication
(10) Pub. No.: US 2004/0075846 A1
(43) Pub. Date: Apr. 22, 2004

(54) Strike zone detector

(76) Inventor: Jeffrey C. Ritterhouse, Phoenix, AZ (US)

Correspondence Address: ELLIS & VENABLE, PC, 101 NORTH FIRST AVE., SUITE 1875, PHOENIX, AZ, 85003, US

(21) Appl. No.: 10/456,820

(22) Filed: Jun. 6, 2003

Related U.S. Application Data
(60) Provisional application No. 60/387,205, filed on Jun. 7, 2002.

(51) Int. Cl. G01B 11/14

(52) U.S. Cl. 356/621

(57) ABSTRACT

This invention is a device that enables a baseball pitcher to accurately measure both the location and speed of a baseball. The device consists of a frame with embedded laser diodes and corresponding photo detectors in both the horizontal and vertical directions. Certain photo detectors correspond to a typical strike zone which may be varied. When a baseball is thrown through the frame, the baseball breaks the path of at least one of the light beams from the laser diodes in the vertical and sometimes the horizontal direction. The resulting interruption of the path of light generates a signal that indicates not only whether a ball or a strike has been thrown, but the speed of the pitch is calculated as well.

This application claims benefit of provision application serial No. 60/387,205.

### FIELD OF THE INVENTION

The present invention relates to the field of baseball, and more specifically, to electronic pitch detection machines that are capable of determining whether ball thrown by a pitcher lands within a batter's given strike zone, and the speed at which the pitch has been thrown.

### BACKGROUND

Hurling pitch after pitch at an unseen target, pitchers in baseball have long faced a problem during practices and warming-up in preparation for a ballgame. Pitchers have no way of determining if a given pitch would be called a “strike” or a “ball”. The strike zone is a subjectively defined area, roughly from the knees to the mid-chest of a batter. The strike zone varies from player to player. Currently, the only pitching tools used to assist a pitcher in determining a called strike or ball that are available are devices that outline the area of a single strike zone as a target. Such a system offers little or no feedback to the pitcher.

What is needed is an interactive training tool that will allow pitchers to simulate the calls that umpire will make during an actual game and give feedback on the speed of a pitch. Using the present, invention, a pitcher can experience facing a variety of different sized batters with variable strike zones. The present invention replaces the subjective, invisible strike zone with an objective, tangible target. In addition, the preferred embodiment of the present invention may monitor the count and allow a pitcher to concentrate on areas that need improvement as well as determine the speed at which the pitcher throws the ball. It is also understood that the device may be used to detect other objects such as a football or tennis ball to assist in developing the throwing accuracy of an athlete.

### SUMMARY OF THE INVENTION

It is an object of the present invention to provide an accurate detector of the location of baseballs thrown by a person.

It is a further object of the present invention to provide an adjustable range of boundaries that comprise the zone for a strike or a ball.

It is a further object of the present invention to provide an electronic means of detection of the zone for a strike or a ball.

It is a further object of the present invention to provide an inexpensive means to measure the speed of a thrown pitch.

It is also a further object of the present invention to provide a tracking means for counting the number of successful strikes and balls.

The novel features that are considered characteristic of the invention are set forth with particularity in the appended claims. The invention itself, however, both as to its structure and its operation together with the additional object and advantages thereof will best be understood from the following description of the preferred embodiment of the present invention when read in conjunction with the accompanying drawings. Unless specifically noted, it is intended that the words and phrases in the specification and claims be given the ordinary and accustomed meaning to those of ordinary skill in the applicable art or arts. If any other meaning is intended, the specification will specifically state that a special meaning is being applied to a word or phrase. Likewise, the use of the words “function” or “means” in the Description of Preferred Embodiments is not intended to indicate a desire to invoke the special provision of 35 U.S.C. §112, paragraph 6 to define the invention. To the contrary, if the provisions of 35 U.S.C. §112, paragraph 6, are sought to be invoked to define the invention(s), the claims will specifically state the phrases “means for” or “step for” and a function, without also reciting in such phrases any structure, material, or act in support of the function. Even when the claims recite a “means for” or “step for” performing a function, if they also recite any structure, material or acts in support of that means of step, then the intention is not to invoke the provisions of 35 U.S.C. §112, paragraph 6. Moreover, even if the provisions of 35 U.S.C. §112, paragraph 6, are invoked to define the inventions, it is intended that the inventions not be limited only to the specific structure, material or acts that are described in the preferred embodiments, but in addition, include any and all structures, materials or acts that perform the claimed function, along with any and all known or later-developed equivalent structures, materials or acts for performing the claimed function.

### BRIEF DESCRIPTION OF THE DRAWINGS

FIG. 1 is a front view of the preferred embodiment showing the outer boundaries of the device where laser diodes and laser detection devices are stored that create an invisible vertical plane where the location of a projectile may be detected.

FIG. 2 is a circuit diagram showing the logic circuitry where the inputs are connected directly to the laser detection devices at one end, and the outputs are connected to the logic circuitry in FIG. 3.

FIG. 3 is a circuit diagram showing the logic circuitry where the inputs are connected to the outputs from the logic circuitry shown in FIG. 2, and the outputs are connected to the pitch count display devices as shown in FIG. 1.

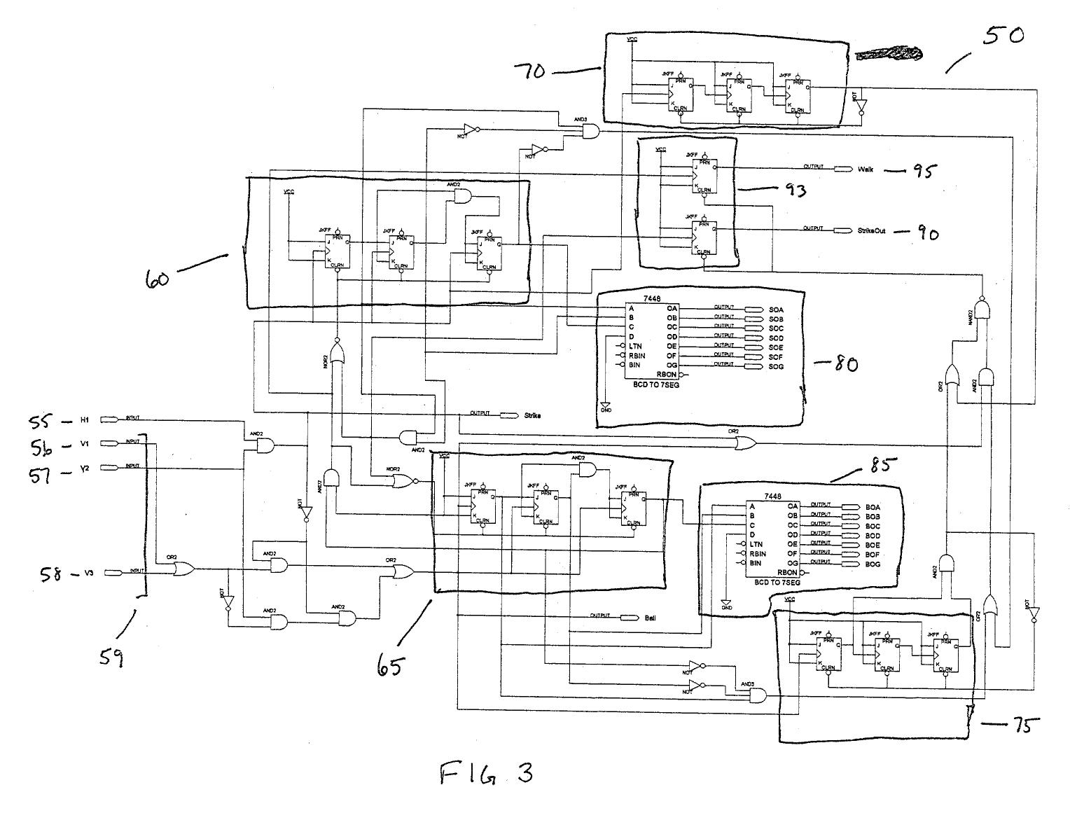

FIG. 4 is a frontal view of a baseball passing through the device and how it breaks the light beams generated by the laser diodes.

FIG. 5 is a circuit block diagram that is used to measure the speed of a thrown ball that passes through the device.

### DESCRIPTION OF PREFERRED EMBODIMENTS

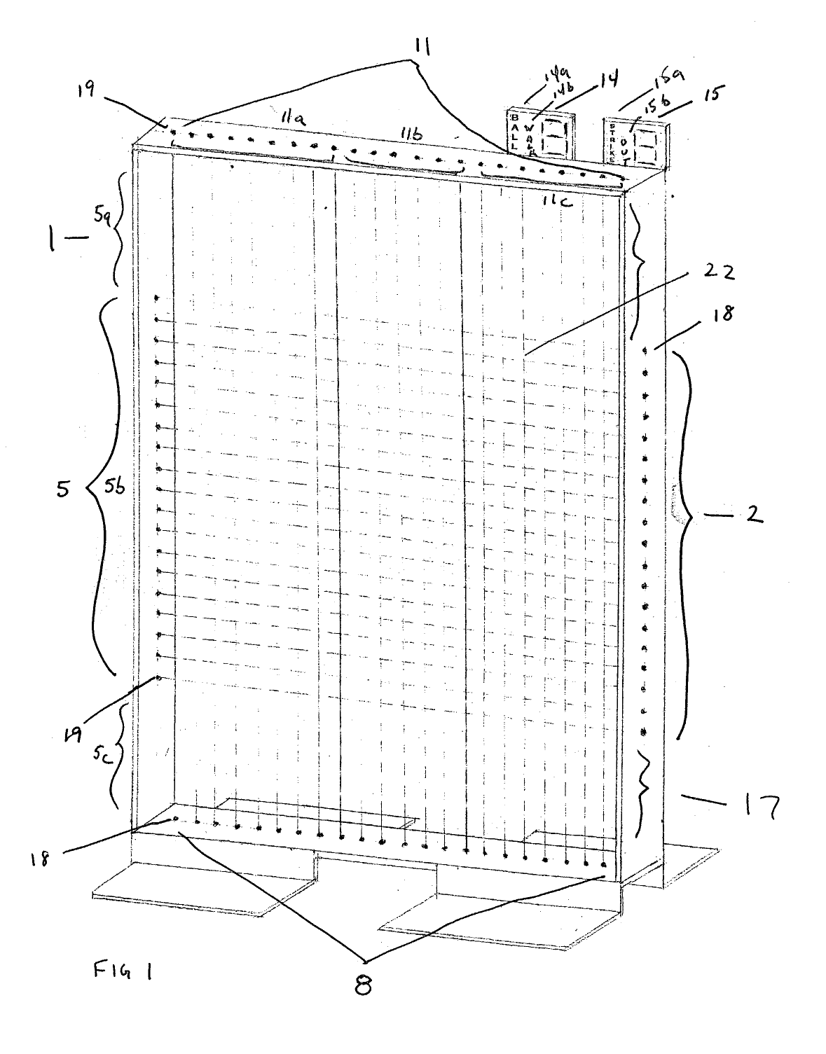

As described in FIG. 1, the strike zone detector 1 is shown as a generally rectangular shaped frame 17. Embedded within the frame 17 are a plurality of laser diodes 18 and photo detectors 19. The frame 17 may be comprised of a plurality of panels such that each panel may be of any shape. The laser diodes are divided into two groups: the horizontal group 8, and the vertical group 2. The photo detectors are also divided into two groups: the horizontal group 11, and the vertical group 5.

The vertical group 2 comprises the laser diodes 18 that, when used in conjunction with photo detectors 19 from group 5, are capable of detecting a projectile that passes through the frame 17 at various points. The laser diodes 18 are embedded along either vertical side of the frame 17. Each laser diode 18 within group 2 is spaced equidistant from the next successive laser diode 18. In the preferred embodiment, the laser diodes 18 in group 2 are shown on the right side of the frame 17. Usually, the spacing between each laser diode 18 is no greater than the diameter of a standard baseball. For each corresponding laser diode 18, there is a corresponding photo detector 19 that is located directly across from the laser diode 18.

Typically, the vertical portion of a strike zone of a batter is from the batter's chest to his knees. Therefore, depending upon the height of a batter, a strike zone in baseball may vary. The individual laser diodes 18 at the opposite sides of group 2 may be turned on or off depending on the actual or imaginary height of a batter in order to accurately detect the batter's strike zone. The number of laser diodes 18 required to be turned on should be no less than H/X+1 wherein “H” is the largest height in inches of the strike zone and “X” is the diameter of the baseball being used. Each of the laser diodes 18 in group 2 may be connected to a common power source or they may be individually powered.

As for the laser diodes 18 in vertical group 8, the same principals are used for the vertical group 2. The vertical group 2 represents the horizontal portion of the strike zone that encompasses the width of home plate in baseball. The number of laser diodes 18 required in group 8 should be no less then P/X+1, wherein “P” is the largest width in inches of a standard home plate, and “X” is the diameter of the baseball being used. However, in order to accurately detect a ball or a strike within the entire frame 17, the number of laser diodes 18 should cover the entire width of the upper and lower portions of the frame 17. In the preferred embodiment, the laser diodes 18 in group 8 are on the bottom of the frame 17. For each corresponding laser diode 18, there is a corresponding photo detector 19 that is located directly across from the laser diode 18 on the top portion of the frame. Each of the laser diodes 18 in group 8 may be connected to a common power source or they may be powered by individual power sources.

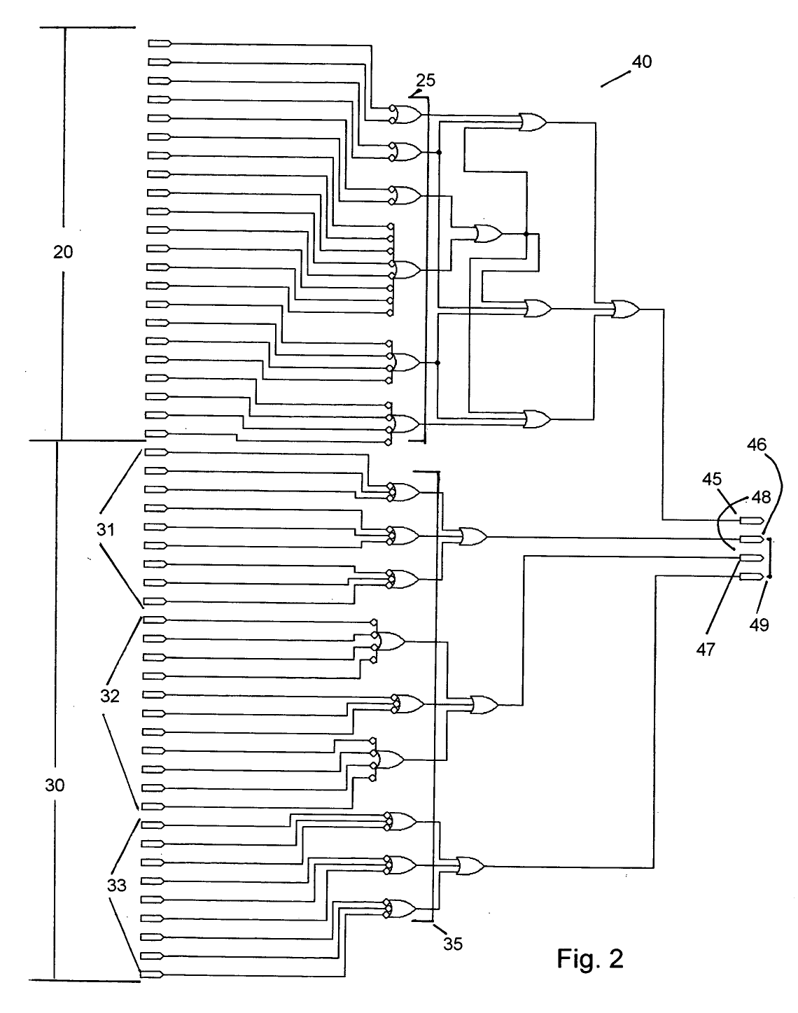

Each individual laser diode 18, when powered on, focuses a beam of light on to its corresponding photo detector 19. When all of the laser diodes 18 are turned on, the end result is a rectangular planar field 22 of laser light. All of the photo detectors 19 in groups 5 and 11 are connected to a logic circuit 40 as shown in FIG. 2. Each of the individual photo detectors 19 in group 5 are connected to the inputs 20, while the individual photo detectors 19 in group 11 are connected to the inputs 30. Each of the inputs 20 are connected to one of a plurality of digital “or” gates 25, while each of the inputs 30 are connected to one of a plurality of digital “or” gates 35. It is understood that a single or gate with inputs totaling the number of photo detectors 19 may be substituted for each of the “or” gates in 25 and 35. In the preferred embodiment, the inputs 30 are divided into three sections: those photo detectors 19 that represent the area to the left of home plate, those photo detectors 19 that represent the area covering the width of home plate, and those photo detectors 19 that represent the area to the right of home plate. This embodiment is used should the user wish to detect projectiles thrown in particular locations within the horizontal portion of the strike zone.

In the preferred embodiment, each of the outputs 45, 46, 47 and 48 of the circuit 40 are connected to the inputs 55, 56, 57 and 58 of circuit 50 respectively. However, it is understood that only outputs 45 and 47 need to be connected to inputs 55 and 57 respectively in order to make the minimum determination of whether a strike has been thrown by the pitcher.

When a pitcher throws a baseball through the frame 17, the baseball will pass through the plane of the frame 17 in one of nine regions of the frame. Each region is defined by a rectangular plane with horizontal and vertical coordinates. The upper left coordinate, is marked by elements 5a and 11a. The lower right coordinate is marked by elements 5c and 1c. When all of the lasers diodes 18 are active each of the photo detectors 19 will detect the light emitted from the diodes 18 and turn on. When a baseball passes through region 5a or 5c, the baseball is entirely outside of the vertical portion of the strike zone as defined in region 5b thereby resulting in a pitched “ball”. A baseball passing through region 5b/11a or 5b/11c is within the vertical portion of the strike zone, but is outside of the horizontal region of the strike zone thereby also resulting in a pitched “ball”. The only time a pitched “strike” occurs is when the baseball simultaneously passes through the horizontal and vertical portions of the strike zone as defined in regions 5b and 11b.

When the baseball passes through the frame 17, it will break the plane of laser diodes 18 in at least one location in region 11a, 11b or 11c for a short period of time thereby turning off the corresponding photo detector 18 in 11 for a short period of time.

Only when the baseball passes through frame 17 in region 5b will it break the plane of laser diodes 18 in region 5b thereby turning off the corresponding photo detector 18 in 5 for a short period of time.

As mentioned, a strike occurs when the baseball passes through region 5b and 11b simultaneously. When the baseball breaks the plane and interrupts the light from one of the laser diodes 18 in regions 5b and 11b, the corresponding photo detectors in regions 5b and 11b are turned off for a brief moment. At that instant, the inputs 55 and 57 are turned off thereby causing the strike counter 60 to increment by one. When the strike counter increments by one, the display driver 80 increments by one and flashes the number of strikes on the strike indicator 15. The strike display 15 also receives a signal that flashes the word “strike” on it to indicate that the pitcher has successfully thrown a strike at 15a.

When the baseball is thrown in any region other than those defined by 5b, the corresponding photo detectors 18 in the region where the ball was thrown are turned off for a brief moment. At that instant, one of the inputs 56, 57 or 58 will turn off thereby causing the ball counter 65 to increment by one. When the ball counter increments by one, the display driver 85 increments by one and flashes the number of balls on the ball indicator 14. The ball indicator 14 also receives a signal that flashes the word “ball” on it to indicate that the pitchers has successfully thrown a ball at 14a.

When the pitcher throws three strikes before he throws four balls, the “strike out” indicator 90 is turned on and is flashed on the strike display 15b. When the pitcher throws four balls before he throws three strikes, the “walk” indicator 95 is turned on and is flashed on the walk display 14b. When the next successive pitch is thrown, the next pitch counters 70 or 75 will reset all counters and indicators to their default position of off.

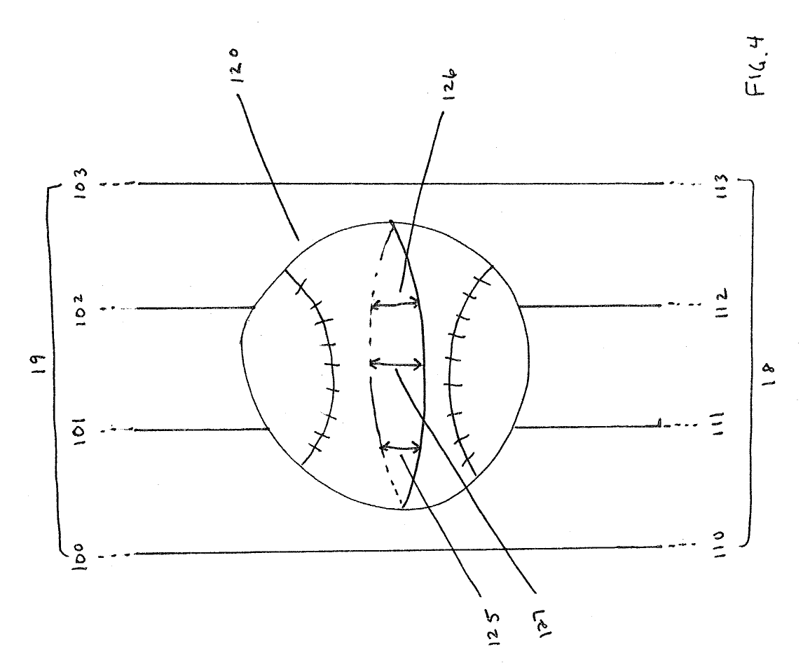

The speed of the pitch is also measured by determining the time it takes the baseball to pass through the plane of light emitted by the laser diodes. As shown in FIG. 4, as the baseball travels normal to the plane of laser diodes 110 through 113. In the preferred embodiment, at least two laser diodes 18 should be capable of emitting light that strikes the baseball 120 as it passes through the frame 17. When the light beams 111 and 112 are broken, the length of time that the light beams 111 and 112 will not reach the corresponding photo detectors 101 and 102 is a function of the position of the baseball 120. When a beam of light passes directly over the center of the baseball 120, the length of time that the beam of light would not reach the corresponding photo detector would be at its maximum because the entire diameter 127 of the ball will pass over the beam of light. If a beam of light ever passes directly over the diameter 127 of the baseball 120, each of the light beams to the left and right of the diameter 127 will not strike the ball. On all other occasions, at least two beams of light will strike the baseball 120 as in FIG. 4 where beams 111 and 112 strike the baseball 120 over points left and right of the diameter 127. The distance that the ball must travel through the light beams is shown at 125 and 126.

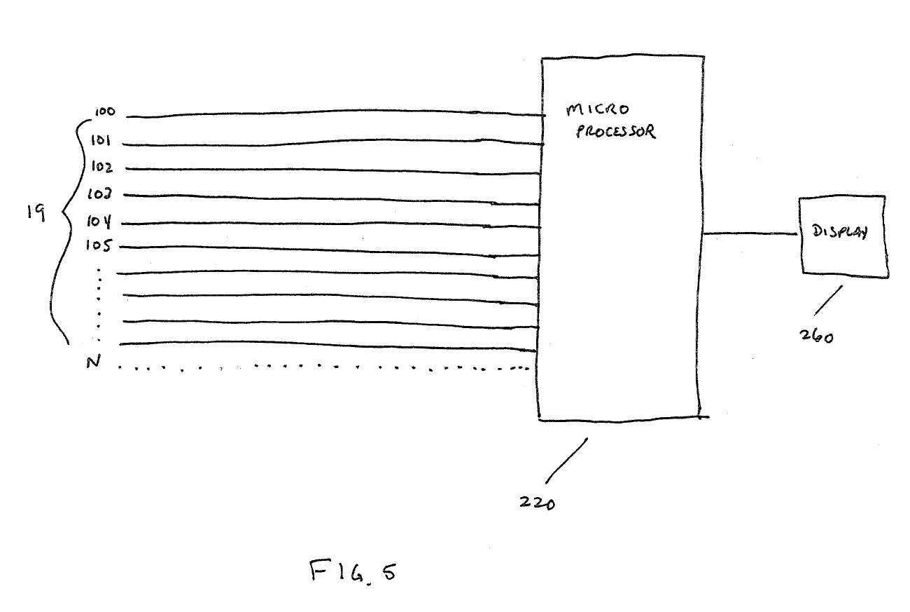

The speed at which the ball travels can then be determined by the circuit shown in FIG. 5. As shown, each of the individual photo detectors 19 are fed into a microprocessor 220. In the preferred embodiment, only the photo detectors 19 on the upper portion of the frame 17 are used as they would cover the entire area of the frame 17. The microprocessor 220 simultaneously samples the individual photo detectors 19 to determine if a signal exists on any given photo detector 19. The sampling rate of the microprocessor 220 is sufficiently high such that the time it would take to sample all of the photo detectors 19 would be significantly faster than the time it would take for a baseball to pass through a beam of light. For example, with photo detector 101, when a logical 1 is detected for photo detector 101, it is presumed that no baseball has impeded the light beam emitting from the corresponding laser diode 110. If a logical 1 is received, the microprocessor 220 does nothing and awaits the next sampling from photo detector 101. This sequence of events continues until a logical 0 is detected from at least one photo detector 19.

If for example a logical 0 is detected from photo detector 101, it is presumed that a baseball has passed through the frame and has impeded a light beam from the laser diode 111. The microprocessor 220 immediately checks to see if either photo detector 100 or photo detector 102 has a logical 0 on its path. If neither photo detector 100 or 102 has a logical zero, then it is presumed that the center portion of the baseball is passing through photo detector 101. The microprocessor 220 will then determine the time it takes until a logical 1 is detected once again by photo detector 101. That time is then processed through a formula that measures the speed of the pitch as a function of the diameter of the baseball and length of time that a logical 0 was detected on photo detector 101.

If however, in addition to a logical 0 being detected on photo detector 101, a logical 0 is detected on either photo detector 100 or 102, it is presumed that a baseball is passing through the frame as illustrated in FIG. 4 such that the light beams are being impeded at two separate locations on the baseball 120. The microprocessor will determine the time it takes for logical 1s to reappear at photo detector 101 and either detector 100 or 102. The microprocessor 220 will then sum the times and mathematically determine the speed of the ball as a function of the diameter of the baseball 220. The results are then displayed on the display 260. It is understood that the higher the density of laser diodes 18 and photo detectors 19 that are used, the more accurate the reading of the speed of the pitched baseball will be.

The preferred embodiment of the invention is described above in the Drawings and Description of Preferred Embodiments. While these descriptions directly describe the above embodiments, it is understood that those skilled in the art may conceive modifications and/or variations to the specific embodiments shown and described herein. Any such modifications or variations that fall within the purview of this description are intended to be included therein as well. Unless specifically noted, it is the intention of the inventor that the words and phrases in the specification and claims be given the ordinary and accustomed meanings to those of ordinary skill in the applicable art(s). The foregoing description of a preferred embodiment and best mode of the invention known to the applicant at the time of filing the application has been presented and is intended for the purposes of illustration and description. It is not intended to be exhaustive or to limit the invention to the precise form disclosed, and many modifications and variations are possible in the light of the above teachings. The embodiment was chosen and described in order to best explain the principles of the invention and its practical application and to enable others skilled in the art to best utilize the invention in various embodiments and with various modifications as are suited to the particular use contemplated.

What is claimed is:

1. A device for detecting the location of a projectile as at a certain instant in time comprising:
A. a first plurality of light emitting sources fixed along a first vertical panel;
B. a first plurality of photo detectors fixed along a second vertical panel; said first and second vertical panels being substantially parallel to each other such that each individual light emitting source from said first plurality of light emitting sources may be focused directly upon a corresponding individual photo detector from said first plurality of photo detectors such that when each of said individual light emitting sources is focused directly upon said individual photo detector, said each individual photo detector when turned on forms a first plurality of parallel light beams;
C. a second plurality of light emitting sources fixed along a first horizontal panel;
D. a second plurality of photo detectors fixed along a second horizontal panel; said first and second horizontal panels being substantially parallel to each other such that each individual light emitting source from said second plurality of light emitting sources may be focused directly upon a corresponding individual photo detector from said second plurality of photo detectors such that when each of said individual light emitting sources is focused directly upon said individual photo detector, said each individual photo detector when turned on forms a second plurality of parallel light beams;
E. a power source coupled to said first and second plurality of light emitting sources;
F. a locator circuit coupled to said first and second plurality of photo detectors comprising:
i. a first logic gate comprising a plurality of input signals and an output signal such that said output signal changes when at least one of said first plurality of photo detectors and when at least one of said second plurality of photo detectors are turned off if a projectile passes perpendicularly through said first and second plurality of parallel light beams such that said output signal of said first logic gate is coupled to a strike indicator that indicates a projectile has passed through said first and second plurality of parallel light beams when said output signal changes.

2. The detection device in claim 1 wherein:
A. said first plurality of photo detectors further comprises a left region, a middle region and a right region such that the output signal of said first logic gate changes only when at least one of said first plurality of photo detectors is turned off from the middle region and at least one of said photo detectors is turned off from said second plurality of photo detectors.

3. The detection device in claim 2 further comprising:
A. a ball indicator;
B. a second logic gate comprising a plurality of input signals and an output signal such that said ball indicator is coupled to the output signal of said second logic gate and that said ball indicator indicates a projectile has passed through the detection device when:
i. at least one of said first plurality of photo detectors is turned off from the left region or right region or;
ii. at least one of said first plurality of photo detectors is turned off from said middle region and all of said second plurality of photo detectors remain turned on.

4. The detection device in claim 3 wherein said locator circuit further comprises:
A. a strike counter;
B. a ball counter;
C. a pitch count display; said pitch count display being coupled to said strike counter and said ball counter;
D. said strike counter having a value from at least zero to four such that said strike counter increments by one when the output of said first logic gate is changed and said pitch count display capable of displaying the value of said strike counter;
E. said ball counter having a value from at least zero to four such that said ball counter increments by one when the output of said second logic gate is changed and said pitch count display capable of displaying the value of said ball counter;
F. said strike and ball counters capable of being reset to zero when said strike counter reaches the value of three or when said ball counter reaches the value of four.

5. The detector device as described in claim 1 further comprising:
A. a timing circuit for measuring the speed of travel of the projectile;
B. said timing circuit further comprising:
i. a microprocessor having a plurality of inputs;
ii. said inputs of said microprocessor being coupled to each one of said first plurality of photo detectors in a sequential order;
iii. said microprocessor being capable of detecting whether any of said each one of said first plurality of photo detectors is turned off such that when said microprocessor detects that at least one of said first plurality of photo detectors is turned off that said microprocessor detects whether at least one of the adjacent photo detectors has been turned off;
iv. said microprocessor measuring the length of time that said at least one of said first plurality of photo detectors and said at least one of the adjacent photo detectors has been turned off;
v. said microprocessor measuring the speed of said projectile as a function of the length of time said first plurality of photo detectors and said at least one of the adjacent photo detectors has been turned off and as a function of the width of said projectile.
